(19) United States
(12) Patent Application Publication
(10) Pub. No.: US 2013/0063409 A1
(43) Pub. Date: Mar. 14, 2013

(54) PIXEL STRUCTURE, HYBRID DISPLAY APPARATUS, AND DRIVING METHOD

(71) Applicants: Yung-Hsiang Chiu, Miaoli County (TW); Heng-Yin Chen, Hsinchu County (TW); Heng-Lin Pan, New Taipei City (TW); Chang-An Ho, Keelung City (TW); Chen-Wei Lin, Kaohsiung City (TW); Chih-Chieh Hsu, Hsinchu City (TW)

(72) Inventors: Yung-Hsiang Chiu, Miaoli County (TW); Heng-Yin Chen, Hsinchu County (TW); Heng-Lin Pan, New Taipei City (TW); Chang-An Ho, Keelung City (TW); Chen-Wei Lin, Kaohsiung City (TW); Chih-Chieh Hsu, Hsinchu City (TW)

(73) Assignee: INDUSTRIAL TECHNOLOGY RESEARCH INSTITUTE, Hsinchu (TW)

(21) Appl. No.: 13/437,941

(22) Filed: Apr. 3, 2012

(30) Foreign Application Priority Data
Sep. 9, 2011 (TW) 100132722

(51) Int. Cl. G09G 5/00

(52) U.S. Cl. 345/211

(57) ABSTRACT

A pixel structure including a first switch device, an amplifying device, a first display unit, a second switch device, and a second display unit is provided. The first switch device is coupled to a scan line, a data line, and the amplifying device. The amplifying device is coupled to a bias voltage. The first display unit is coupled to the amplifying device and a switching voltage. The second switch device is coupled to the first display unit, the first switch device, and the second display unit. The second display unit is coupled to a common voltage. A hybrid display apparatus and a driving method are also provided.

### CROSS-REFERENCE TO RELATED APPLICATION

This application claims the priority benefit of Taiwan application serial no. 100132722, filed on Sep. 9, 2011. The entirety of the above-mentioned patent application is hereby incorporated by reference herein and made a part of this specification.

### BACKGROUND

1. Technical Field

The disclosure generally relates to a display technique, and more particularly, to a pixel structure, a hybrid display apparatus, and a driving method of a pixel structure.

2. Related Art

With the advancements of display techniques, more and more types of displays are being developed. When categorized by different display mediums, these displays may be grouped into the electrophoresis display, the electrowetting display (EWD), the liquid crystal display (LCD), the cholesteric liquid crystal display, the plasma display panel (PDP), the organic light-emitting diode display (OLED display), the field emission display, etc. Among these types of displays, the PDP, the OLED display, and the field emission displays are self-emitting displays, whereas the electrophoresis display, the EWD, the LCD, and the cholesteric liquid crystal displays are light regulating displays.

Since the self-emitting displays can emit light by themselves, therefore, by controlling the brightness of the light emission, different gray levels can be generated to produce an image frame. On the other hand, the light regulating displays can not emit light by themselves, and these displays may be further grouped into transmissive, reflective, and transflective displays. The transmissive light regulating displays typically include backlight modules to provide the backlight source. By allowing different quantities of light to pass, the light regulating displays form different gray levels and produce an image frame. The reflective light regulating displays need to be used under a sufficient ambient light source. By generating different degrees of reflectivities for the ambient light, the light regulating displays form different gray levels and produce an image frame. The transflective light regulating displays combine the functionalities of the transmissive and reflective displays.

Typically speaking, displays with different display mediums have their respective merits and faults. For example, the OLED display has a fast response time and a vivid image display, but consumes more power because the OLED display uses current to drive the display medium. On the other hand, although the EWD cannot self-emit, the EWD consumes a low power. Therefore, when characteristics of displays with different mediums can be combined, then such a display is suitable for use under many operating conditions.

### SUMMARY

An exemplary embodiment of the disclosure provides a pixel structure, including a first switch device, an amplifying device, a first display unit, a second switch device, and a second display unit. The first switch device has a first control terminal, a first terminal, and a second terminal, in which the first control terminal is coupled to a scan line, and the first terminal is coupled to a data line. The amplifying device has a second control terminal, an input terminal, and an output terminal, in which the second control terminal is coupled to the second terminal, and the input terminal is coupled to a bias voltage. The first display unit has an anode and a cathode, in which the anode is coupled to the output terminal, and the cathode is coupled to a switching voltage. The second switch device has a third control terminal, a third terminal, and a fourth terminal, in which the third control terminal is coupled to the cathode, and the third terminal is coupled to the second terminal. The second display unit has a fifth terminal and a sixth terminal. The fifth terminal is coupled to the fourth terminal, and the sixth terminal is coupled to a common voltage. When the switching voltage is at a first high level, electrical conduction is formed between the third terminal and the fourth terminal of the second switch device, so the second display unit is in a display state corresponding to a data signal from the data line in respond to a scan signal from the scan line and the data signal from the data line. When the switching voltage is at a first low level, the bias voltage is at a second high level, and the first display unit provides a display state corresponding to the data signal in respond to the scan signal and the data signal, in which the first high level is higher than the first low level, and the second high level is higher than the first low level.

Another exemplary embodiment of the disclosure provides a hybrid display apparatus, including a driving unit, a plurality of first display units, and a plurality of second display units. The driving unit is integrated on a single substrate. The first display units are disposed on the substrate and electrically connected to the driving unit. The second display units are disposed on the substrate and electrically connected to the driving unit. A display medium of the first display units is different from a display medium of the second display units. Moreover, the driving unit is configured for driving the first display units and the second display units.

Another embodiment of the disclosure provides a driving method for driving a display apparatus. The driving method includes the following steps. A switching voltage and a scan signal are respectively set at a first high level and a second high level, so as to respectively turn on a first switch device and a second switch device, and accordingly a data signal flows by the first switch device and the second switch device in sequence, so a second display unit of a pixel of the display apparatus is in a display state corresponding to the data signal. The switching voltage and the scan signal are respectively set at a first low level and the second high level, so as to turn on the first switch device, and accordingly the data signal flows by the first switch device, and the data signal works in cooperation with the first low level to enable an amplifying device, in which the amplifying device outputs a driving signal corresponding to the scan signal to a first display unit of the pixel, so as to drive the first display unit to provide a brightness corresponding to the data signal.

Several exemplary embodiments accompanied with figures are described in detail below to further describe the disclosure in details.

### BRIEF DESCRIPTION OF THE DRAWINGS

The accompanying drawings are included to provide a further understanding, and are incorporated in and constitute a part of this specification. The drawings illustrate exemplary embodiments and, together with the description, serve to explain the principles of the disclosure.

FIG. 1 is a schematic view of a hybrid display apparatus according to an exemplary embodiment.

FIG. 2 is a circuit diagram of a hybrid display apparatus according to an exemplary embodiment.

FIG. 3 is a waveform diagram of a pixel structure in FIG. 2.

FIG. 4 is a circuit diagram of a hybrid display apparatus according to another exemplary embodiment.

FIG. 5 is a waveform diagram of a pixel structure in FIG. 4.

FIG. 6 is a block diagram of a hybrid display apparatus according to another exemplary embodiment.

FIG. 7 is a schematic cross-sectional view of the hybrid display apparatus depicted in FIG. 6.

FIGS. 8A and 8B are operating waveform diagrams of the pixel structures in the hybrid display apparatus depicted in FIG. 6 respectively under a self-emitting display mode and a light regulating display mode.

FIG. 9 is a flow chart illustrating a driving method according to an exemplary embodiment.

### DESCRIPTION OF EMBODIMENTS

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

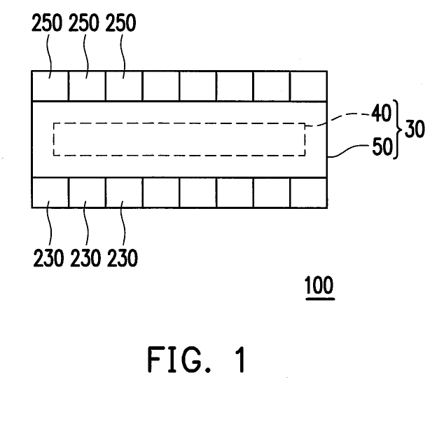

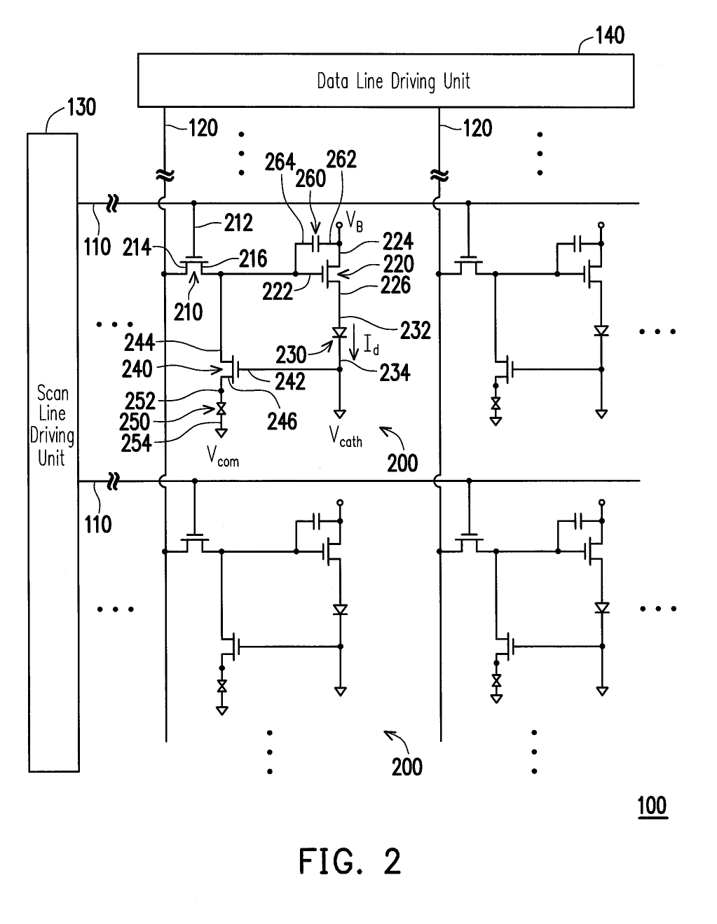

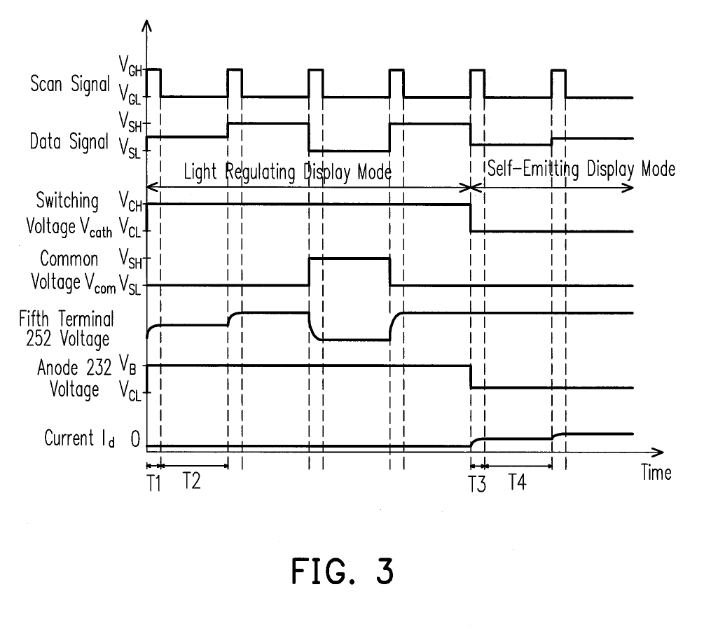

FIG. 1 is a schematic view of a hybrid display apparatus according to an exemplary embodiment. FIG. 2 is a circuit diagram of the hybrid display apparatus depicted in FIG. 1. FIG. 3 is a waveform diagram of a pixel structure in FIG. 2. Referring to FIGS. 1, 2, and 3, a hybrid display apparatus 100 of an embodiment includes a driving unit 40, a plurality of first display units 230, and a plurality of second display units 250. The driving unit 40 is integrated on a single substrate 50. The first display units 230 are disposed on the substrate 50 and electrically connected to the driving unit 40. The second display units 250 are disposed on the substrate 50 and electrically connected to the driving unit 40. A display medium of the first display units 230 is different from a display medium of the second display units 250. Moreover, the driving unit 40 is configured for driving the first display units 230 and the second display units 250. In the present embodiment, the driving unit 40 is a pixel circuit. However, in other embodiments, the driving unit 40 may also be other suitable driving circuits. In the present embodiment, the driving unit 40 and the single substrate 50 may form a driving interface 30. In addition, in other embodiments, the display medium of the first display units 230 may also be substantially the same as the display medium of the second display units 250. In the present embodiment, the first display units 230 and the second display units 250 are respectively disposed at two sides of the substrate 50. However, in other embodiments, the first display units 230 and the second display units 250 may also be disposed at a same side of the substrate 50.

In the present embodiment, the driving unit 40 includes a plurality of scan lines 110, a plurality of data lines 120, and a plurality of pixel structures 200. Each of the pixel structures 200 includes a first switch device 210, an amplifying device 220, and a second switch device 240. Each of the first display units 230 is coupled to one of the pixel structures 200, and each of the second display units 250 is coupled to one of the pixel structures 200. The first switch device 210 has a first control terminal 212, a first terminal 214, and a second terminal 216. The first control terminal 212 is coupled to one of the scan lines 110, and the first terminal 214 is coupled to one of the data lines 120. Specifically, the pixel structures 200 on a same row are coupled to a same scan line 110, and the pixel structures 200 on different rows are coupled to different scan lines 110. Moreover, the pixel structures 200 on a same column are coupled to a same data line 120, and the pixel structures 200 on different columns are coupled to different data lines 120.

In the present embodiment, the first switch device 210 is a field effect transistor, and the first control terminal 212, the first terminal 214, and the second terminal 216 are respectively a gate, a source, and a drain of the field effect transistor. However, in other embodiments, the first switch device 210 may also be a bipolar transistor or other suitable switching devices.

The amplifying device 220 has a second control terminal 222, an input terminal 224, and an output terminal 226. The second control terminal 222 is coupled to the second terminal 216, and the input terminal 224 is coupled to a bias voltage V_{B}. In the present embodiment, the bias voltage V_{B} is an operating voltage, for example. Moreover, in the present embodiment, the amplifying device 220 is a field effect transistor, and the second control terminal 222, the input terminal 224, and the output terminal 226 are respectively a gate, a source, and a drain of the field effect transistor. However, in other embodiments, the amplifying device 220 may also be a bipolar transistor or other suitable current amplifying devices.

The first display unit 230 has an anode 232 and a cathode 234. The anode 232 is coupled to the output terminal 226, and the cathode 234 is coupled to a switching voltage V_{cath}. In the present embodiment, the first display unit 230 is an organic light-emitting diode (OLED), for example. However, in other embodiments, the first display unit 230 may also be a light-emitting diode (LED), a liquid crystal display (LCD) unit, a bistable display unit, an electrophoresis display unit, an electrowetting display (EWD) unit, an electrofluidic technology (EFT) unit, or other suitable display units, in which the electrofluidic technologies include the EWD techniques.

The second switch device 240 has a third control terminal 242, a third terminal 244, and a fourth terminal 246. The third control terminal 242 is coupled to the cathode 234, and the third terminal 244 is coupled to the second terminal 216. In the present embodiment, the second switch device 240 is a field effect transistor, and the third control terminal 242, the third terminal 244, and the fourth terminal 246 are respectively a gate, a source, and a drain of the field effect transistor. However, in other embodiments, the second switch device 240 may also be a bipolar transistor or other suitable switching devices.

The second display unit 250 has a fifth terminal 252 and a sixth terminal 254. The fifth terminal 252 is coupled to the fourth terminal 246, and the sixth terminal 254 is coupled to a common voltage V_{com}. In the present embodiment, the second display unit 250 is an EWD unit, for example. However, in other embodiments, the second display unit 250 may also be an OLED, an LED, a LCD unit, a bistable display unit, an electrophoresis display unit, an EFT unit, or other suitable display units. In the present embodiment, the display medium of the first display units 230 is different from the display medium of the second display units 250. For example, the display medium of the first display unit 230 is a film of the OLED, for example, and the display medium of the second display unit 250 is an ink and an electrolytic solution of the EWD unit, for instance, and therefore the display mediums of the two display units 230 and 250 are different.

When the switching voltage V_{cath} is at a high level V_{CH} (e.g. at a time T1), the high level V_{CH} is higher than a threshold voltage of the second switch device 240, and electrical conduction is formed between the third terminal 244 and the fourth terminal 246 of the second switch device 240 so the second display unit 250 is in a display state corresponding to a data signal (as shown in FIG. 3) from the data line 120 in respond to a scan signal (as shown in FIG. 3) from the scan lines 110 and the data signal (as shown in FIG. 3) from the data line 120. Specifically, when the second switch device 240 is turned on, and the scan signal is at a high level V_{GH} that is higher than a threshold voltage of the first switch device 210, the first switch device 210 is turned on. The data signal is transmitted in sequence through the first switch device 210 and the second switch device 240 to the second display unit 250. By varying the data signal levels (e.g., changing to one of the values from high level V_{SH} to low level V_{SL}), a voltage difference (i.e., a voltage difference between the data signal and the common voltage V_{com}) variation is generated between the two terminals of the second display unit 250, and therefore the display state of the second display unit 250 changes. In the present embodiment, the scan signal and the data signal may be respectively provided by a scan line driving unit 230 and a data line driving unit 140. The scan lines 110 are coupled to the scan line driving unit 130, and the data lines 120 are coupled to the data line driving unit 140.

In the present embodiment, the second display unit 250 (e.g. an EWD unit) includes an electrolytic solution and an ink disposed on a substrate. When the voltage difference applied on the second display unit 250 increases, the electrolytic solution pushes the ink so an area of the substrate exposed by the ink is enlarged, i.e., an area of the ink covering the substrate shrinks. When the voltage difference applied on the second display unit 250 decreases, the electrolytic solution pushes the ink to a lesser degree so the ink spreads out. Therefore, the area of the ink covering the substrate is enlarged, i.e. the area of the substrate exposed by the ink shrinks The ink may have a black, red, green, or blue color, for example, or other suitable colors. Therefore, when the ink is black, and the voltage difference applied on the second display unit 250 decreases, since the ink covers a large area of the substrate, a color tone of the second display unit 250 darkens. On the other hand, when the voltage difference applied on the second display unit 250 decreases, since the ink covers a smaller area of the substrate, the color tone of the second display unit 250 is lightened. Accordingly, the second display unit 250 can display different gray levels by adjusting the data signal levels.

When the ink is other colors, such as red, and when the voltage difference applied on the second display unit 250 decreases, a hue of the color increases so red becomes more red, for example. When three adjacent pixel structures respectively use a plurality of different color inks, for example, red, green, and blue inks are respectively used, then the hybrid display apparatus 100 can display a color image frame.

In the present embodiment, each of the pixel structures 200 further includes an energy storing device 260 having a ninth terminal 262 and a tenth terminal 264. The ninth terminal 262 is coupled to the input terminal 224, and the tenth terminal 264 is coupled to the second control terminal 222 and the second terminal 216. The energy storing device 260 is configured for maintaining a voltage of the second terminal 216 when the first switch device 210 is turned off. Specifically, the energy storing device 260 is a storage capacitor, for example. When the scan signal is at the high level V_{GH} and the first switch device 210 is turned on, the data signal flows by the first switch device 210 and charges the energy storing device 260. When the scan line is next at the low level V_{GL} (e.g. at a time T2), due to the electric charge stored in the energy storing device 260, the voltage level of the second terminal 216 is maintained at the data signal level when the first switch device 210 is turned on. Therefore, the voltage difference between the two terminals of the second display unit 250 is still maintained at the voltage difference between the data signal when the first switch device 210 is turned on and the common voltage V_{com}. As a result, even when the scan signal changes from the high level V_{GH} to the low level V_{GL} and turns off the first switch device 210, the second display unit 250 can still be maintained in the display state which is the state prior to the first switch device 210 being turned off.

Moreover, when the switching voltage V_{cath} is at the high level V_{CH}, and the scan signal is at the high level V_{GH} so the first switch device 210 is turned on, although the scan signal is transmitted from the first switch device 210 to the amplifying device 220 so that the amplifying device 220 is liable to be turned on, a voltage difference between the bias voltage V_{B} and the high level V_{CH} is not sufficient to cause the first display unit 230 to turn on, and thus the first display unit 230 does not emit light. Therefore, when the switching voltage V_{cath} is at the high level V_{CH}, the pixel structures 200 may be viewed as being in a second display units 250 display mode (e.g. a light regulating display mode).

On the other hand, when the switching voltage V_{cath} is at a low level V_{CL} (e.g., the low level V_{CL} being lower than the threshold voltage of the second switch device 240, and lower than the high level V_{CH}), the bias voltage V_{B} is at a high level (e.g., the high level being higher than the low level V_{CL}, and high enough to drive the first display unit 230), and the first display unit 230 provides a display state corresponding to the data signal (e.g., providing a brightness that corresponds to the data signal) in respond to the scan signal and the data signal.

Specifically, when the switching voltage V_{cath} is at the low level V_{CL}, the second switch device 240 is turned off, so the data signal cannot be transmitted to the second display unit 250. Meanwhile, when the scan signal is at the high level V_{GH} and the first switch device 210 is turned on (e.g. at a time T3), the scan signal is transmitted from the first switch device 210 to the second control terminal 222 of the amplifying device 220. Since the bias voltage is at a high level that is higher than the low level V_{CL}, and the bias voltage is high enough to drive the first display unit 230, therefore the amplifying device 220 generates a current I_{d} corresponding to the data signal. The current I_{d} flows in sequence by the input terminal 224, the output terminal 226, the anode 232 of the first display unit 230, and the cathode 234 of the first display unit 230 to make the first display unit 230 emit light. Next, in the present embodiment, when the scan signal is at the high level V_{GH} and the first switch device 210 is turned on (e.g. at the time T3), the data signal flows by the first switch device 210 and charges the energy storing device 260. When the scan signal is next at the low level V_{GL} (e.g. at a time T4), due to the electric charge stored in the energy storing device 260, the voltage level of the second terminal 216 is maintained at the data signal level which is the level at the time the first switch device 210 is turned on. Therefore, the voltage level of the second control terminal 222 is still maintained at the data signal level when the first switch device 210 is turned on. As a result, even when the scan signal changes from the high level V_{GH} to the low level V_{GL} so as to turn off the first switch device 210, the first display unit 230 can still maintain a light emitting brightness as that before the first switch device 210 is turned off Therefore, when the switching voltage V_{cath} is at the low level V_{CL}, the pixel structures 200 is in a first display units 230 display mode (e.g. a self-emitting mode).

In the present embodiment, when in the second display units 250 display mode (e.g. the light regulating display mode), the common voltage V_{com} may respectively switch to the low level V_{SL} and the high level V_{SH} at different times, so the second display unit 250 generates a polarity inversion. After the operation of the scan signal, data signal, switching voltage V_{cath}, and the common voltage V_{com} as shown in FIG. 3, the fifth terminal 252 voltage, the anode 232 voltage, and the current I_{d} generate the changes depicted in FIG. 3.

In the present embodiment, the pixel structures 200 may all be coupled to a switching voltage V_{cath}, may all be coupled to a common voltage V_{com}, and may all be coupled to a bias voltage V_{B}. Therefore, when the switching voltage V_{cath} is at the high level V_{CH}, all of the pixel structures 200 are in the light regulating display mode. Moreover, when the switching voltage V_{cath} is at the low level V_{CL}, all of the pixel structures 200 are in the self-emitting display mode.

In another embodiment, the pixel structures 200 may also be respectively coupled to different switching voltages V_{cath}. When the pixel structures 200 are coupled to switching voltages V_{cath} that are all at the high level V_{CH}, all of the pixel structures 200 are in the light regulating display mode. In other words, the hybrid display apparatus 100 is in the light regulating display mode. When the pixel structures 200 are coupled to switching voltages V_{cath} that are all at the low level V_{CL}, the hybrid display apparatus 100 is in the self-emitting display mode. In addition, when the pixel structures 200 are coupled to switching voltages V_{cath} with a portion at the high level V_{CH} and another portion at the low level V_{CL}, the pixel structures 200 coupled to the high level V_{CH} are in the second display units 250 display mode (i.e. the light regulating display mode), and the pixel structures 200 coupled to the low level V_{CL} are in the first display units 230 display mode (i.e. the self-emitting display mode). Therefore, the hybrid display apparatus 100 is in a mixed mode that is partially in the first display units 230 display mode and partially in the second display units 250 display mode (i.e. the mixed mode with light regulating display and self-emitting display).

Moreover, in the present embodiment, when the scan signal of FIG. 3 is at the low level V_{GL} (e.g., at time T2 or time T4), the scan signals of the other scan lines may be respectively set at the high level V_{GH} according to a certain suitable sequence. Accordingly, the hybrid display apparatus 100 can drive different rows of pixel structures 200 according to this sequence, in which a period of the scan signal is a frame time, for example. For instance, a frame time may be the time T1 plus the time T2, and a frame time may also be the time T3 plus the time T4.

In the present embodiment, because both the first display unit and the second display unit are used in a same pixel structure 200, a dual mode display function can be achieved. Therefore, when a user operates the hybrid display apparatus 100 outdoors or in an area with plenty of light, and the user does not have a high demand for color and motion response speed (e.g., when viewing text or static images), the light regulating display mode can be used to view the images, and thereby achieve an energy saving effect. Moreover, when the user is in an environment with insufficient lighting, or the user has a high demand for color and motion response speed, the self-emitting mode can be used to view the images. Additionally, in the present embodiment, since the switching of the light regulating display mode and the self-emitting display mode is determined by whether the switching voltage V_{cath} is at the high level V_{CH} or the low level V_{CL}, the pixel structures 200 can be easily controlled, thereby reducing the circuit complexity and the costs. Moreover, the hybrid display apparatus 100 of the present embodiment can achieve an effect of respectively adopting different display modes in different regions of an image frame at the same time. For example, the light regulating display mode may be used in a region displaying text, and the self-emitting display mode may be used in a region displaying pictures or motion pictures, thereby achieving an effective management of energy and display effect.

In the present embodiment, the second display unit 250 in each of the pixel structures 200 is disposed on a transmission path of a light emitted by the first display unit 230. In other words, the second display unit 250 is stacked above the first display unit 230, so that the area occupied by each of the pixel structures 200 can be effectively reduced, and the resolution of the hybrid display apparatus 100 can be increased. When the hybrid display apparatus 100 uses the self-emitting display mode, the pixel structures 200 may be first switched to the light regulating display mode, such that the ink converges to expose a portion of the substrate. Next, the pixel structures 200 are switched to the self-emitting display mode at a subsequent time, so the light emitted by the first display unit 230 can penetrate the portion of the substrate not covered by the ink, and the effect of an self-emitting display can be achieved.

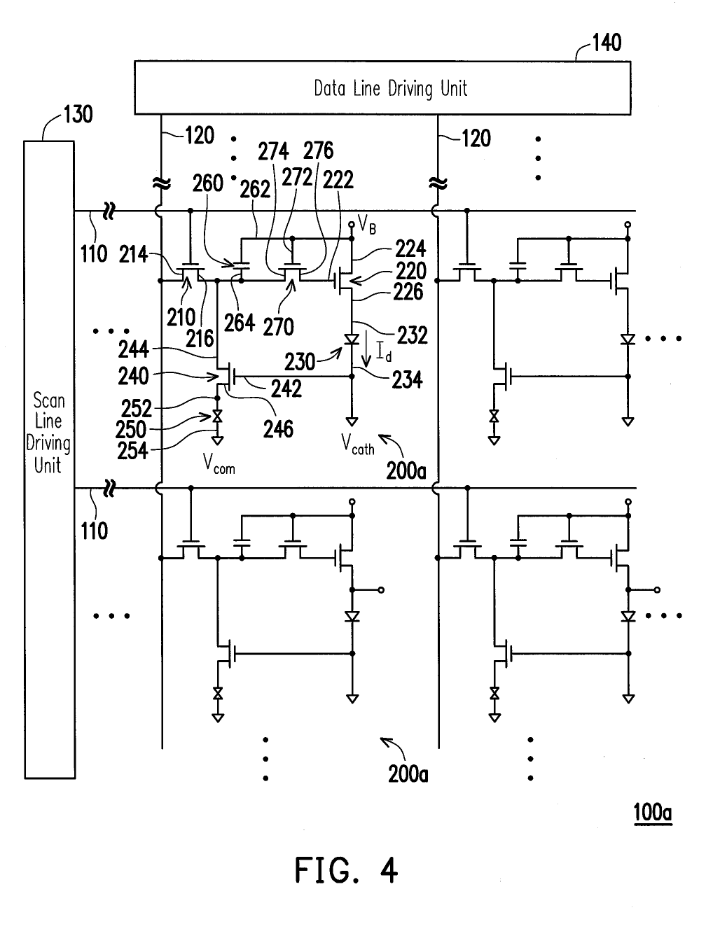

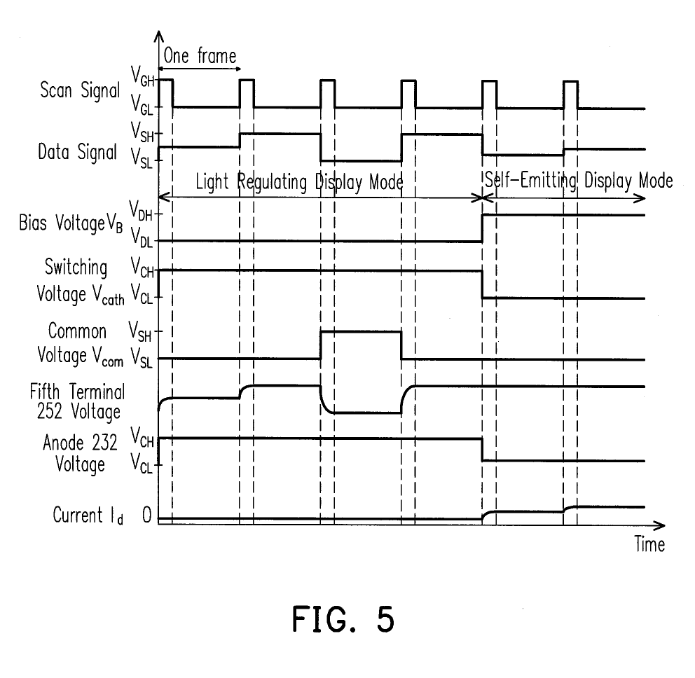

FIG. 4 is a circuit diagram of a hybrid display apparatus according to another exemplary embodiment. FIG. 5 is a waveform diagram of a pixel structure in FIG. 4. Referring to FIGS. 4 and 5, a hybrid display apparatus 100a of the present embodiment is similar to the hybrid display apparatus 100 in FIG. 2, and the differences therebetween are described below. In the hybrid display apparatus 100a of the present embodiment, each of the pixel structures 200a further includes a third switch device 270, in which the third switch device 270 has a fourth control terminal 272, a seventh terminal 274, and an eighth terminal 276. The fourth control terminal 272 is coupled to the input terminal 224, the seventh terminal 274 is coupled to the second terminal 216, and the eighth terminal 276 is coupled to the second control terminal 222. In the present embodiment, the third switch device 270 is a field effect transistor, and the fourth control terminal 272, the seventh terminal 274, and the eighth terminal 276 are respectively a gate, a source, and a drain of the field effect transistor. However, in other embodiments, the third switch device 270 may also be a bipolar transistor or other suitable switching devices. In the present embodiment, when the switching voltage V_{cath} is at the high level V_{CH}, the bias voltage V_{B} is at a low level V_{DL} (the low level being lower than the threshold voltage of the third switch device 270), and the third switch device 270 is turned off. Accordingly, when in the light regulating display mode, the scan signal is not transmitted to the second control terminal 222, such that the voltage level of the second control terminal 222 is lower than the threshold voltage of the amplifying device 220. Therefore, the amplifying device 220 is in the turned off state, and the input terminal 224 is also at the low level V_{DL}. As a result, the amplifying device 220 can withstand a lower voltage stress in the light regulating display mode, and the operating lifetime of the amplifying device 220 is enhanced. Moreover, the threshold voltage of the amplifying device 220 is not likely to vary as the operating time span increases to affect the display accuracy of the pixel structures.

Moreover, when the switching voltage V_{cath} is at the low level V_{CL}, the bias voltage V_{B} is at a high level V_{DH} (the high level V_{DH} being higher than the threshold voltage of the third switch device 270, and higher than the low level V_{CL}), and the third switch device 270 is turned on. Accordingly, when the scan signal is at the high level V_{GH} such that the data signal can be transmitted to the second control terminal 222, the high level V_{DH} relative to the low level V_{CL} is also high enough to turn on the first display unit 220. Therefore, the amplifying device 220 outputs a current I_{d} corresponding to the data signal, so as to drive the first display unit 220 to provide a brightness corresponding to the data signal.

In the present embodiment, the ninth terminal of the energy storing device 260 is coupled to the input terminal 224 and the fourth control terminal 272, and the tenth terminal 264 of the energy storing device 260 is coupled to the second terminal 216 and the seventh terminal 274. The energy storing device 260 is configured for maintaining a voltage of the second terminal 216 when the first switch device 210 is turned off.

In the present embodiment, when the waveforms of the scan signal, data signal, bias voltage V_{B}, switching voltage V_{cath}, and the common voltage V_{com} are as depicted in FIG. 5, the fifth terminal 252 voltage, the anode 232 voltage, and the current I_{d} generate the changes illustrated in FIG. 5.

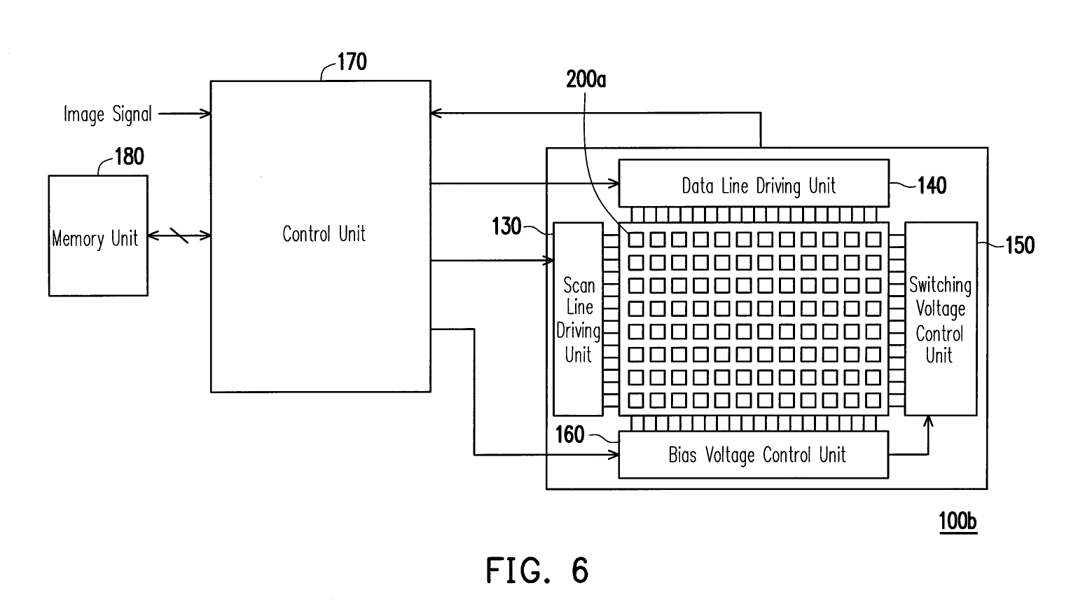

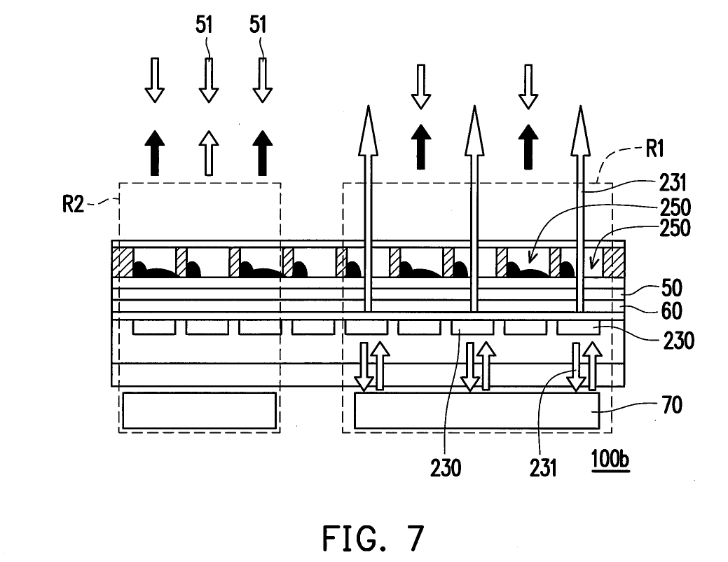

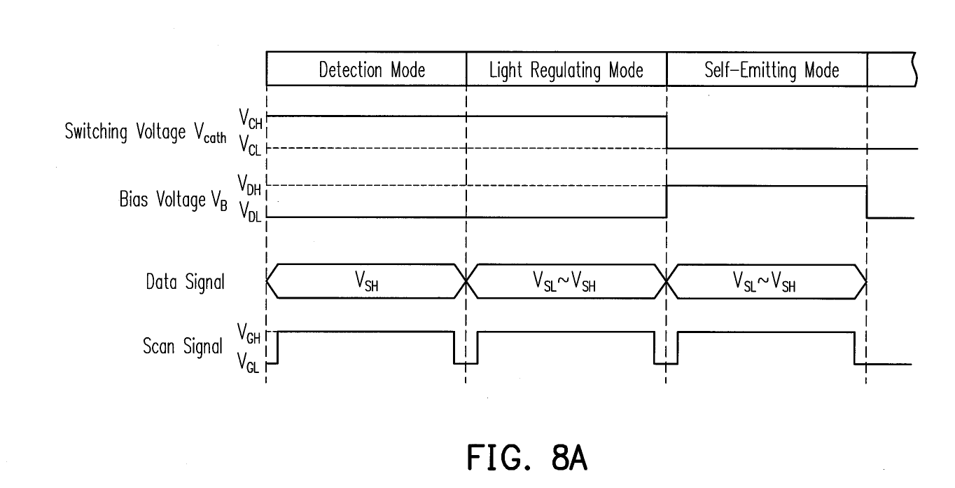

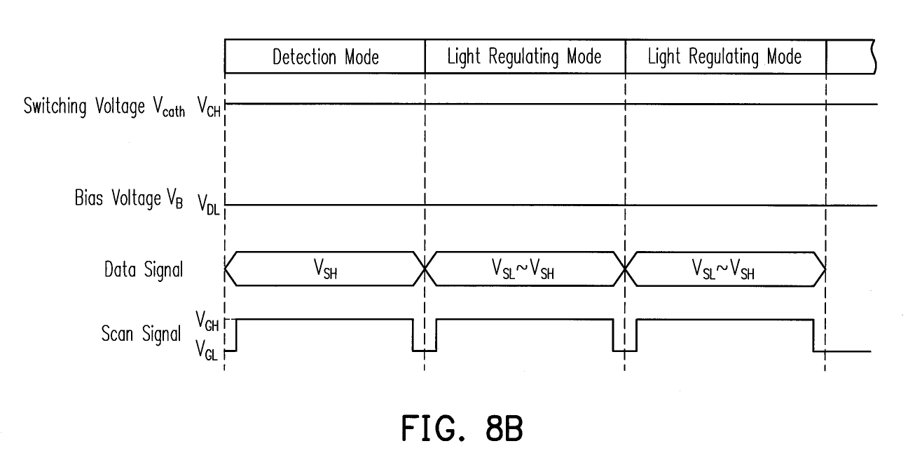

FIG. 6 is a block diagram of a hybrid display apparatus according to another exemplary embodiment. FIG. 7 is a schematic cross-sectional view of the hybrid display apparatus depicted in FIG. 6. FIGS. 8A and 8B are operating waveform diagrams of the pixel structures in the hybrid display apparatus depicted in FIG. 6 respectively under the self-emitting display mode and the light regulating display mode. Referring to FIGS. 6, 7, 8A, and 8B, a hybrid display apparatus 100b of the present embodiment adopts the pixel structures 200a, the scan line driving unit 130, and the data line driving unit 140 depicted in FIG. 4. Moreover, the switching voltage V_{cath} and the bias voltage V_{B} may be respectively controlled by a switching voltage control unit 150 and a bias voltage control unit 160. In addition, the hybrid display apparatus 100b further includes a control unit 170 electrically connected to the scan line driving unit 130, the data line driving unit 140, the switching voltage control unit 150, and the bias voltage control unit 160. The control unit 170 is configured for accepting an image signal from an image signal source, and determining a display mode (e.g., the light regulating display mode, the self-emitting display mode, or a mixed mode of the two display modes) to use according to the characteristics of the image signal, so as to control the driving methods of the scan line driving unit 130, the data line driving unit 140, the switching voltage control unit 150, and the bias voltage control unit 160. Furthermore, in the present embodiment, the control unit 170 may determine the subsequent driving methods of the scan line driving unit 130, the data line driving unit 140, the switching voltage control unit 150, and the bias voltage control unit 160 according to an overall feedback signal from the pixel structures 200a. Moreover, the control unit 170 may be coupled to a memory unit 180, in which the memory unit 180 may be configured for registering the data from the control unit 170.

In the present embodiment, the hybrid image apparatus 100b includes a substrate 50. The first switch device 210, the amplifying device 220, the second switch device 240, and the third switch device 270 of the pixel structures 200a are respectively a thin film transistor formed in a thin film transistor layer 60 on the substrate 50. The substrate 50 is a transparent substrate, for example. The first display units 230 are disposed below the thin film transistor layer 60, and the second display units 250 are disposed above the substrate 50. Moreover, in the present embodiment, a reflection plate 70 may be disposed below the first display units 230 for reflecting a light 231 emitted by the first display units 230 or for reflecting an ambient light 51. The reflection plate 70 may be movable to a region which requires a reflective panel effect to be generated, and a transmissive panel effect is produced for the regions which the reflection plate 70 does not reside. In the present embodiment, a region R1 is in the self-emitting display mode, for example, and the image is formed by the light 231 emitted by the first display units 230. Furthermore, in the region R1, the light 231 emitted by the first display units 230 passes through the substrate 50 and the second display units 250 in sequence to be transmitted outside. Moreover, a region R2 is in the light regulating display mode, for example, and the image is formed by the second display units 250 reflecting the ambient light 51.

In the present embodiment, when the hybrid display apparatus 100b receives the image signal, the hybrid display apparatus 100b is first in a detection mode. The control unit 170 may determine whether to use the light regulating display mode or the self-emitting display mode next, in which an operating waveform diagram of the self-emitting display mode may be as illustrated in FIG. 8A, and an operating waveform diagram of the light regulating display mode may be as illustrated in FIG. 8B. In the detection mode, the switching voltage V_{cath} of the pixel structures 200a is at the high level V_{CH}, and the bias voltage V_{B} is at the low level V_{DL}. Meanwhile, the scan signal is at the high level V_{GH} to reset the second display units 250. In other words, the ink of the second display units 250 covers a smaller area of the substrate, so a light transmittance of the second display units 250 is the higher. Next, in the self-emitting display mode depicted in FIG. 8A, the hybrid display apparatus 100b may be first set in the light regulating display mode, and here the switching voltage V_{cath} is still at the high level V_{CH} and the bias voltage V_{B} is still at the low level V_{DL}. However, the data signal may be adjusted between the high level V_{SH} and the low level V_{SL}, so as to adjust the light transmittance of the second display units 250 and to determine an overall brightness during the subsequent self-emitting display mode. Thereafter, the hybrid display apparatus 100b is set in the self-emitting display mode, and here the switching voltage V_{cath} is at the low level V_{CL} and the bias voltage V_{B} is at the high level V_{DH}. The data signal may be adjusted between the high level V_{SH} and the low level V_{SL}, so as to adjust the brightness of the first display units 230.

On the other hand, referring to the light regulating display mode depicted in FIG. 8B, in the two light regulating display modes after the detection mode, the switching voltage V_{cath} and the bias voltage V_{B} both remain as those in the detection mode, i.e. the switching voltage V_{cath} and the bias voltage V_{B} are respectively at the high level V_{CH} and the low level V_{DL}. In the first light regulating display mode after the detection mode, the second display units 250 are first initialized, and the second display units 250 actually display images during the second light regulating display mode after the detection mode.

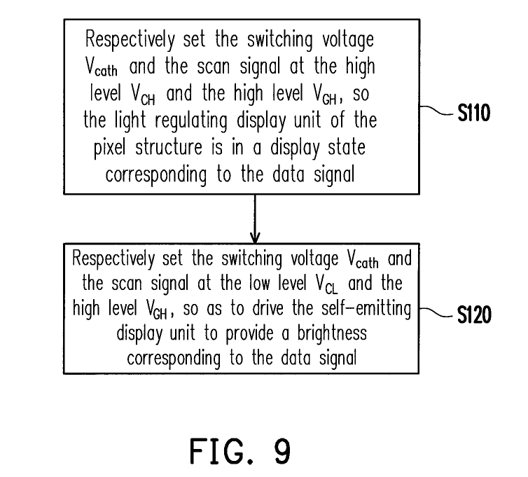

FIG. 9 is a flow chart illustrating a driving method according to an exemplary embodiment. Please refer to FIGS. 2, 3, and 9. The driving method of the present embodiment may be used for driving the pixel structures 200 of FIG. 2, the pixel structures 200a of FIG. 4, or the pixel structures of the other embodiments. The driving of the pixel structures 200 is used as an illustrative example. The driving method of the present embodiment includes the following steps. In a Step S110, the switching voltage V_{cath} and the scan signal are respectively set at the high level V_{CH} and the high level V_{GH}, so as to respectively turn on the first switch device 210 and the second switch device 240. Accordingly, the data signal flows by the first switch device 210 and the second switch device 240 in sequence, so the second display unit 250 of the pixel structures 200 is in the display state corresponding to the data signal. The other details of the Step S110 have been provided in the description of the light regulating display mode corresponding to the embodiment depicted in FIG. 2, and thus will not be repeated hereinafter.

In a Step S 120, the switching voltage V_{cath} and the scan signal are respectively set at the low level V_{CL} and the high level V_{GH}, so as to turn on the first switch device 210. Accordingly, the data signal flows by the first switch device 210 and works in cooperation with the low level V_{CL} to enable the amplifying device 220. The amplifying device 220 outputs a driving signal (e.g. the current I_{d}) corresponding to the scan signal to the first display unit 230 of the pixel structures 200, so as to drive the first display unit 230 to provide a display state (e.g. brightness) corresponding to the data signal. The other details of the Step S120 have been provided in the description of the self-emitting display mode corresponding to the embodiment depicted in FIG. 2, and thus will not be repeated hereinafter.

Embodiments of the disclosure do not limit the driving method to first executing the Step S 110, then executing the Step S120. In another embodiment, the Step S120 may be first executed, then the Step S110 is executed. In other embodiments, Steps S110 and S120 may be alternately executed. Alternatively, in other embodiments, the Step S110 may be executed on a portion of the pixels of the hybrid display apparatus 100, and the Step S120 may be executed on another portion of the pixels of the hybrid display apparatus 100.

The driving method of the present embodiment may further include storing the data signal when the scan signal is at the high level V_{CH}. When the scan signal is at the low level V_{GL} and the first switch device 210 is turned off, the stored data signal sets the second display unit 250 in a display state corresponding to the data signal, or the stored data signal sets the first display unit 230 to provide the brightness corresponding to the data signal. In the present embodiment, the method of storing the data signal is by using the energy storing device 260 to maintain the voltage level of the second terminal 216. Since other details can be found in the embodiment depicted in FIG. 2, repeated description is not provided hereafter.

The driving method of the present embodiment achieves switching of the pixel structures 200 to the light regulating display mode or the self-emitting display mode by setting the switching voltage V_{cath} at the high level V_{CH} or the low level V_{CL}. Accordingly, the driving method of the present embodiment is simple, and therefore the circuit structure can be simplified and the costs can be reduced.

A driving method of another embodiment may be used for the pixel structures 200a depicted in FIG. 4. Referring to FIGS. 4 and 5, in the present embodiment, when the switching voltage V_{cath} is at the high level V_{CH}, the amplifying device 220 is cut off from the data signal. In other words, by setting the bias voltage V_{B} at the low level V_{DL} to turn off the third switch device 270, the amplifying device 220 is cut off from the data signal. Therefore, the voltage stress of the amplifying device 220 can be reduced, thereby lengthening the lifespan of the amplifying device 220, and the threshold voltage of the amplifying device 220 is stable.

In view of the foregoing, according to embodiments of the disclosure, since both the first display unit and the second display unit are used in a same pixel structure, a dual mode display function can be achieved. Therefore, when the user operates the hybrid display apparatus outdoors or in an area with plenty of light, and the user does not have a high demand for color and motion response speed (e.g., when viewing text or static images), the light regulating display mode can be used to view the images, and thereby achieve an energy saving effect. Moreover, when the user is in an environment with insufficient lighting, or the user has a high demand for color and motion response speed, the self-emitting mode can be used to view the images. Additionally, in embodiments of the disclosure, since the switching of the light regulating display mode and the self-emitting display mode is determined by whether the switching voltage is at the high level or the low level, the control method and the driving method of the pixel structures are simple, thereby effectively reducing the circuit complexity and the costs. Moreover, the hybrid display apparatus according to the embodiments of the disclosure can achieve the effect of respectively adopting different display modes in different regions of an image frame. For example, the light regulating display mode may be used in the region displaying text, and the self-emitting display mode may be used in the region displaying pictures or motion pictures, thereby achieving an effective management of energy and display effect.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A pixel structure, comprising:
a first switch device having a first control terminal, a first terminal, and a second terminal, wherein the first control terminal is coupled to a scan line, and the first terminal is coupled to a data line;
an amplifying device having a second control terminal, an input terminal, and an output terminal, wherein the second control terminal is coupled to the second terminal, and the input terminal is coupled to a bias voltage;
a first display unit having an anode and a cathode, wherein the anode is coupled to the output terminal, and the cathode is coupled to a switching voltage;
a second switch device having a third control terminal, a third terminal, and a fourth terminal, wherein the third control terminal is coupled to the cathode, and the third terminal is coupled to the second terminal; and
a second display unit having a fifth terminal and a sixth terminal, wherein the fifth terminal is coupled to the fourth terminal, and the sixth terminal is coupled to a common voltage, wherein when the switching voltage is at a first high level, electrical conduction is formed between the third terminal and the fourth terminal of the second switch device so that the second display unit is in a display state corresponding to a data signal from the data line in respond to a scan signal from the scan line and the data signal from the data line, and when the switching voltage is at a first low level, the bias voltage is at a second high level, and the first display unit provides a display state corresponding to the data signal in respond to the scan signal and the data signal, the first high level is higher than the first low level, the second high level is higher than the first low level, and a display medium of the first display unit is different from a display medium of the second display unit.

2. The pixel structure as claimed in claim 1, further comprising a third switch device having a fourth control terminal, a seventh terminal, and an eighth terminal, wherein the fourth control terminal is coupled to the input terminal, the seventh terminal is coupled to the second terminal, and the eighth terminal is coupled to the second control terminal, and when the switching voltage is at the first high level, the bias voltage is at a second low level so that the third switch device is turned off, and the second low level is lower than the second high level.

3. The pixel structure as claimed in claim 2, wherein the third switch device is a field effect transistor, and the fourth control terminal, the seventh terminal, and the eighth terminal are respectively a gate, a source, and a drain of the field effect transistor.

4. The pixel structure as claimed in claim 2, further comprising an energy storing device having a ninth terminal and a tenth terminal, wherein the ninth terminal is coupled to the input terminal and the fourth control terminal, the tenth terminal is coupled to the second terminal and the seventh terminal, and the energy storing device is configured for maintaining a voltage of the second terminal when the first switch device is turned off.

5. The pixel structure as claimed in claim 1, further comprising an energy storing device having a ninth terminal and a tenth terminal, wherein the ninth terminal is coupled to the input terminal, the tenth terminal is coupled to the second control terminal and the second terminal, and the energy storing device is configured for maintaining a voltage of the second terminal when the first switch device is turned off.

6. The pixel structure as claimed in claim 5, wherein the energy storing device is a storage capacitor.

7. The pixel structure as claimed in claim 1, wherein the first display unit is an organic light-emitting diode, a light-emitting diode, a liquid crystal display unit, a bistable display unit, an electrophoresis display unit, an electrofluidic technology unit, or an electrowetting display unit.

8. The pixel structure as claimed in claim 1, wherein the second display unit is an electrowetting display unit, an organic light-emitting diode, a light-emitting diode, a liquid crystal display unit, a bistable display unit, an electrofluidic technology unit, or an electrophoresis display unit.

9. The pixel structure as claimed in claim 1, wherein the second display unit is disposed on a transmission path of a light emitted by the first display unit.

10. The pixel structure as claimed in claim 1, wherein the first switch device is a first field effect transistor, the first control terminal, the first terminal, and the second terminal are respectively a gate, a source, and a drain of the first field effect transistor, the amplifying device is a second field effect transistor, and the second control terminal, the input terminal, and the output terminal are respectively a gate, a source, and a drain of the second field effect transistor, the second switch device is a third field effect transistor, and the third control terminal, the third terminal, and the fourth terminal are respectively a gate, a source, and a drain of the third field effect transistor.

11. A hybrid display apparatus, comprising:
a driving unit integrated on a single substrate;
a plurality of first display units disposed on the substrate and electrically connected to the driving unit;
a plurality of second display units disposed on the substrate and electrically connected to the driving unit, wherein the driving unit is configured to drive the first display units and the second display units.

12. The hybrid display apparatus as claimed in claim 11, wherein the driving unit comprises:
a plurality of scan lines;
a plurality of data lines; and
a plurality of pixel structures, each of the pixel structures comprising:
a first switch device having a first control terminal, a first terminal, and a second terminal, wherein the first control terminal is coupled to one of the scan lines, and the first terminal is coupled to one of the data lines;
an amplifying device having a second control terminal, an input terminal, and an output terminal, wherein the second control terminal is coupled to the second terminal, and the input terminal is coupled to a bias voltage, each of the first display units is coupled to one of the pixel structures, each of the first display units has an anode and a cathode, the anode is coupled to the output terminal, and the cathode is coupled to a switching voltage; and
a second switch device having a third control terminal, a third terminal, and a fourth terminal, wherein the third control terminal is coupled to the cathode, and the third terminal is coupled to the second terminal, each of the second display units is coupled to one of the pixel structures, each of the second display units has a fifth terminal and a sixth terminal, the fifth terminal is coupled to the fourth terminal, and the sixth terminal is coupled to a common voltage, wherein when the switching voltage is at a first high level, electrical conduction is formed between the third terminal and the fourth terminal of the second switch device so that the second display unit is in a display state corresponding to a data signal from the data line in respond to a scan signal from the scan line and the data signal from the data line, and when the switching voltage is at a first low level, the bias voltage is at a second high level, and the first display unit provide a display state corresponding to the data signal in respond to the scan signal and the data signal, the first high level is higher than the first low level, and the second high level is higher than the first low level;
wherein, when the pixel structures are coupled to the switching voltages that are all at the first high level, the hybrid display apparatus is in a second display units display mode, and when the pixel structures are coupled to the switching voltages that are all at the first low level, the hybrid display apparatus is in a first display units display mode.

13. The hybrid display apparatus as claimed in claim 12, wherein when the pixel structures are coupled to switching voltages with a portion at the first high level and another portion at the first low level, the hybrid display apparatus is in a mixed mode partially in the first display units display mode and partially in the second display units display mode.

14. The hybrid display apparatus as claimed in claim 12, wherein each of the pixel structures further comprises a third switch device having a fourth control terminal, a seventh terminal, and an eighth terminal, the fourth control terminal is coupled to the input terminal, the seventh terminal is coupled to the second terminal, and the eighth terminal is coupled to the second control terminal, and when the switching voltage is at the first high level, the bias voltage is at a second low level so the third switch device is turned off, and the second low level is lower than the second high level.

15. The hybrid display apparatus as claimed in claim 14, wherein in each of the pixel structures, the third switch device is a field effect transistor, and the fourth control terminal, the seventh terminal, and the eighth terminal are respectively a gate, a source, and a drain of the field effect transistor.

16. The hybrid display apparatus as claimed in claim 14, wherein each of the pixel structures further comprises an energy storing device having a ninth terminal and a tenth terminal, the ninth terminal is coupled to the input terminal and the fourth control terminal, the tenth terminal is coupled to the second terminal and the seventh terminal, and the energy storing device is configured for maintaining a voltage of the second terminal when the first switch device is turned off.

17. The hybrid display apparatus as claimed in claim 12, wherein each of the pixel structures further comprises an energy storing device having a ninth terminal and a tenth terminal, the ninth terminal is coupled to the input terminal, the tenth terminal is coupled to the second control terminal and the second terminal, and the energy storing device is configured for maintaining a voltage of the second terminal when the first switch device is turned off.

18. The hybrid display apparatus as claimed in claim 17, wherein in each of the pixel structures, the energy storing device is a storage capacitor.

19. The hybrid display apparatus as claimed in claim 12, wherein in each of the pixel structures, the first display unit is an organic light-emitting diode, a light-emitting diode, a liquid crystal display unit, a bistable display unit, an electrophoresis display unit, an electrofluidic technology unit, or an electrowetting display unit.

20. The hybrid display apparatus as claimed in claim 12, wherein in each of the pixel structures, the second display unit is an electrowetting display unit, an organic light-emitting diode, a light-emitting diode, a liquid crystal display unit, a bistable display unit, an electrofluidic technology unit, or an electrophoresis display unit.

21. The hybrid display apparatus as claimed in claim 12, wherein in each of the pixel structures, the second display unit is disposed on a transmission path of a light emitted by the first display unit.

22. The hybrid display apparatus as claimed in claim 12, wherein in each of the pixel structures, the first switch device is a first field effect transistor, the first control terminal, the first terminal, and the second terminal are respectively a gate, a source, and a drain of the first field effect transistor, the amplifying device is a second field effect transistor, and the second control terminal, the input terminal, and the output terminal are respectively a gate, a source, and a drain of the second field effect transistor, the second switch device is a third field effect transistor, and the third control terminal, the third terminal, and the fourth terminal are respectively a gate, a source, and a drain of the third field effect transistor.

23. The hybrid display apparatus as claimed in claim 11, wherein the driving unit is a pixel circuit.

24. The hybrid display apparatus as claimed in claim 11, wherein a display medium of the first display units is different from a display medium of the second display units.

25. The hybrid display apparatus as claimed in claim 11, wherein a display medium of the first display units is substantially the same as a display medium of the second display units.

26. A driving method for driving a display apparatus, comprising:
in each pixel of at least a portion of a plurality of pixels in the display apparatus, respectively setting a switching voltage and a scan signal at a first high level and a second high level, so as to respectively turn on a first switch device and a second switch device, and accordingly flowing a data signal by the first switch device and the second switch device in sequence, so a second display unit of the pixel of the display apparatus is in a display state corresponding to the data signal; and
in each pixel of at least a portion of the plurality of pixels in the display apparatus, respectively setting the switching voltage and the scan signal at a first low level and the second high level, so as to turn on the first switch device, and accordingly flowing the data signal by the first switch device wherein the data signal works in cooperation with the first low level to enable an amplifying device, and wherein the amplifying device outputs a driving signal corresponding to the data signal to a first display unit of the pixel, so as to drive the first display unit to a display state corresponding to the data signal.

27. The driving method as claimed in claim 26, further comprising storing the data signal when the scan signal is at the first high level, wherein when the scan signal is at a first low level and the first switch device is turned off, the stored data signal is used to set the second display unit in a display state corresponding to the data signal, or the stored data signal is used to set the first display unit to provide a display state corresponding to the data signal.

28. The driving method as claimed in claim 26, wherein when the switching voltage is in the first high level, the amplifying device is cut off from the data signal.

29. The driving method as claimed in claim 26, further comprising setting all the pixels of the display apparatus to a state that the first display unit is in a display state corresponding to the data signal, whereby the display apparatus provides a first display unit display mode.

30. The driving method as claimed in claim 26, further comprising setting the pixels of the display apparatus to a state that the second display unit is in a display state corresponding to the data signal, whereby the display apparatus provides a second display unit display mode.

31. The driving method as claimed in claim 26, further comprising setting a portion of the pixels of the display apparatus to a state that the first display unit is in a display state corresponding to the data signal, and setting another portion of the pixels of the display apparatus to a state that the second display unit is in a display state corresponding to the data signal, whereby the display apparatus provides a mixed mode with the first display unit display and the second display unit display.
